(19) United States
(12) Patent Application Publication
(10) Pub. No.: US 2026/0220207 A1
(43) Pub. Date: Jul. 30, 2026

(54) DETERMINATION DEVICE AND DETERMINATION METHOD

(71) Applicant: Panasonic Automotive Systems Co., Ltd., Kanagawa (JP)

(72) Inventor: Hikaru SHIJO, Osaka (JP)

(73) Assignee: Panasonic Automotive Systems Co., Ltd., Kanagawa (JP)

(21) Appl. No.: 19/416,867

(22) Filed: Dec. 11, 2025

(30) Foreign Application Priority Data
Jan. 30, 2025 (JP) 2025-013819
Aug. 6, 2025 (JP) 2025-131154

(51) Int. Cl. G06F 16/906

(52) U.S. Cl. CPC G06F 16/906

(57) ABSTRACT

Determination device includes: logit obtainer that obtains c first logits for c classes by inputting input data to learning model; top-k determiner that determines, as m effective top-k elements, m top-k elements according to a characteristic of learning model from among c top-k elements; first selector that selects m first logits corresponding to the m effective top-k elements from the c first logits; first score deriver that derives an OOD score using the m first logits; and OOD determiner that determines, based on the OOD score, whether input data is OOD data.

### CROSS REFERENCE TO RELATED APPLICATION

The present application is based on and claims priority of Japanese Patent Application No. 2025-013819 filed on Jan. 30, 2025, and Japanese Patent Application No. 2025-131154 filed on Aug. 6, 2025.

### FIELD

The present disclosure relates to a determination device, etc. that perform processing related to machine learning.

### BACKGROUND

Systems having neural networks often make overconfident estimations for out-of-distribution (OOD) data. In other words, when OOD data is input to a learning model such as a neural network as input data, the system may make an incorrect estimation. Therefore, determining whether input data is OOD data, i.e., detecting OOD data, is important for improving the safety of machine learning. OOD data is also referred to as OOD samples. Non Patent Literature (NPL) 1 discloses a technique for detecting OOD data (i.e., OOD detection) using maximum softmax probability (MSP). NPL 2 discloses a technique for OOD detection using MaxLogit.

### CITATION LIST

### Non Patent Literature

NPL 1: Hendrycks, D. and Gimpel, K. A baseline for detecting misclassified and out-of-distribution examples in neural networks. In International Conference on Learning Representations, 2017.
NPL 2: Hendrycks, D., Basart, S., Mazeika, M., Zou, A., Kwon, J., Mostajabi, M., Steinhardt, J., and Song, D. Scaling out-of-distribution detection for real-world settings, 2022. URL https://arxiv.org/abs/1911.11132.

### SUMMARY

However, the above-mentioned NPL 1 and NPL 2 can be improved upon.

In view of this, the present disclosure provides a determination device, etc. capable of improving upon the above related art.

A determination device according to an aspect of the present disclosure includes: a logit obtainer that obtains, as a plurality of first logits, a plurality of logits for a plurality of classes by inputting input data to a learning model; a top-k determiner that determines, as m effective top-k elements, m top-k elements according to a characteristic of the learning model from among a plurality of top-k elements that are each a rank in order of magnitude of logits, where m is an integer of 1 or more; a first selector that selects m first logits corresponding to the m effective top-k elements from the plurality of first logits; a first score deriver that derives an out-of-distribution (OOD) score using the m first logits; and an OOD determiner that determines, based on the OOD score, whether the input data is OOD data.

These general and specific aspects may be implemented using a system, a method, an integrated circuit, a computer program, or a computer-readable recording medium such as compact disc-read only memory (CD-ROM), or any combination of a system, a method, an integrated circuit, a computer program, and a recording medium. The recording medium may be a non-transitory recording medium.

A determination device according to the present disclosure is capable of improving upon the above related art.

Further advantages and effects according to one aspect of the present disclosure will become apparent from the specification and drawings. Such advantages and/or effects are provided by some embodiments and features described in the specification and drawings, but not all of the features are necessarily required.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram for explaining OOD data and ID data.

FIG. 2 is a diagram illustrating an example of estimation results by a learning model.

FIG. 3 is a diagram for explaining a score for OOD detection.

FIG. 4 is a diagram illustrating an example of OOD detection using an OOD score.

FIG. 5 is a diagram for explaining three OOD detection methods.

FIG. 6 is a block diagram illustrating an example of the structure of a determination device using MaxLogit.

FIG. 7 is a flowchart illustrating an example of processing operations by the determination device using MaxLogit.

FIG. 8 is a diagram illustrating an example of a distribution of OOD scores based on Energy.

FIG. 9 is a diagram illustrating an example of determination accuracy using the three OOD detection methods.

FIG. 10 is a block diagram illustrating an example of the structure of a determination device in an embodiment.

FIG. 11 is a diagram for explaining a second process by the determination device in the embodiment.

FIG. 12 is a flowchart illustrating an example of the second process by the determination device in the embodiment.

FIG. 13 is a diagram for explaining a first process by the determination device in the embodiment.

FIG. 14 is a flowchart illustrating an example of the first process by the determination device in the embodiment.

FIG. 15 is a diagram illustrating an example of determination accuracy by the determination device in the embodiment.

### DESCRIPTION OF EMBODIMENT

### (Underlying Knowledge Forming Basis of the Present Disclosure)

The OOD detection techniques disclosed in, for example, NPL 1 and NPL 2, which have been described in the “Background Art” section, will be explained below.

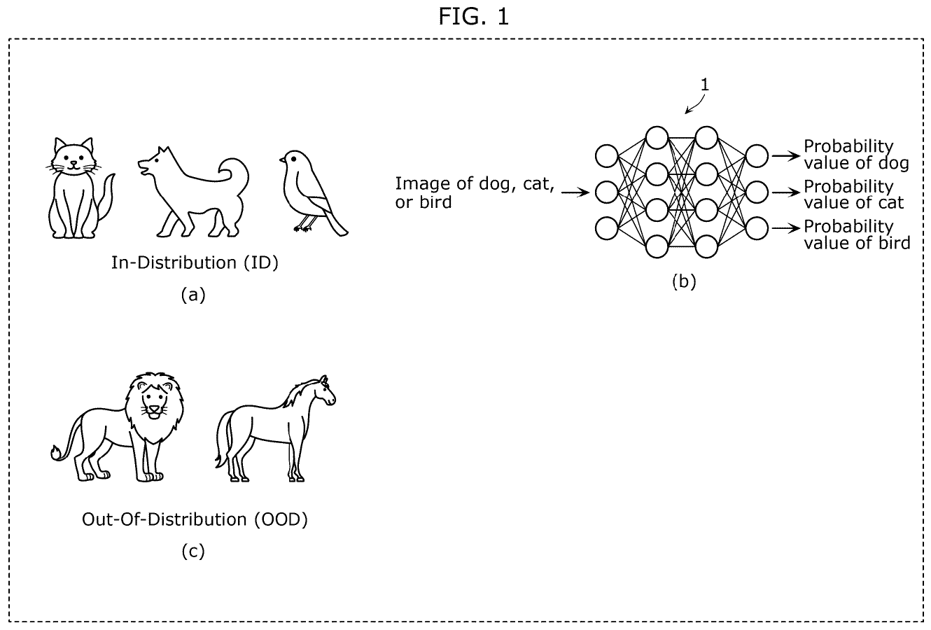

FIG. 1 is a diagram for explaining OOD data and ID data.

Learning model 1 illustrated in (b) in FIG. 1 outputs, in response to input data which is an image, a probability for each of the classes dog, cat, and bird. Specifically, learning model 1 outputs a real-valued logit for each class, and these logits are converted into probabilities using a softmax function. The object corresponding to the class having the maximum probability among these probabilities is estimated as the object depicted in the input data. In other words, the object is estimated to be a dog, a cat, or a bird.

Such learning model 1 is generated by machine learning using a plurality of items of in-distribution (ID) data which are each an image, as illustrated in (a) in FIG. 1. Each of the plurality of items of ID data is an image depicting a dog, an image depicting a cat, or an image depicting a bird. Data other than ID data is out-of-distribution (OOD) data. OOD data is an image depicting a lion, an image depicting a horse, and the like, as illustrated in (c) in FIG. 1.

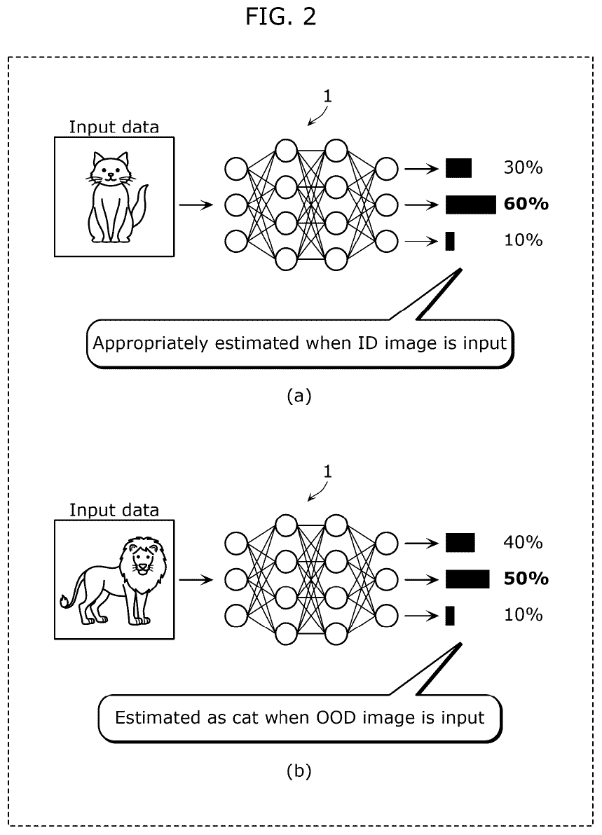

FIG. 2 is a diagram illustrating an example of estimation results by learning model 1.

For example, as illustrated in (a) in FIG. 2, when input data that is an image of a cat is input, learning model 1 outputs a probability of “30%” for a dog, a probability of “60%” for a cat, and a probability of “10%” for a bird. As a result, the object depicted in the input data is estimated to be a cat. Such input data is ID data, for which correct estimation is possible.

As illustrated in (b) in FIG. 2, in response to input of input data that is an image of a lion, learning model 1 outputs a probability of “40%” for a dog, a probability of “50%” for a cat, and a probability of “10%” for a bird. As a result, the object depicted in the input data is estimated to be a cat. Such input data is OOD data, for which incorrect estimation is made.

To suppress such incorrect estimation by learning model 1, techniques for determining whether input data is OOD data (i.e., OOD detection) have been studied. With correct OOD detection, in the example illustrated in (b) in FIG. 2, the input data is determined to be OOD data, without the object depicted in the input data being estimated to be a cat.

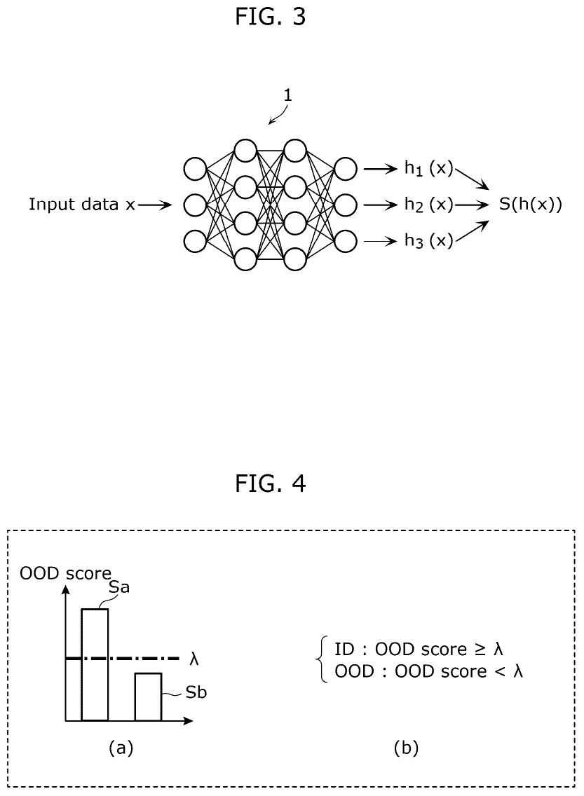

FIG. 3 is a diagram for explaining a score for OOD detection. The “score” is hereinafter also referred to as an OOD score.

Learning model 1 outputs numerical value h1(x) for the dog class, numerical value h2(x) for the cat class, and numerical value h3(x) for the bird class in response to input of input data x. The OOD score is calculated by inputting these numerical values to function S(h(x)).

FIG. 4 is a diagram illustrating an example of OOD detection using an OOD score.

For example, an OOD score is compared with threshold A, as illustrated in (a) in FIG. 4. OOD score Sa obtained for first input data x is greater than or equal to threshold A. In this case, first input data x is determined to be ID data, as illustrated in (b) in FIG. 4. On the other hand, OOD score Sb obtained for second input data x is less than threshold A, as illustrated in (a) in FIG. 4. In this case, second input data x is determined to be OOD data, as illustrated in (b) in FIG. 4.

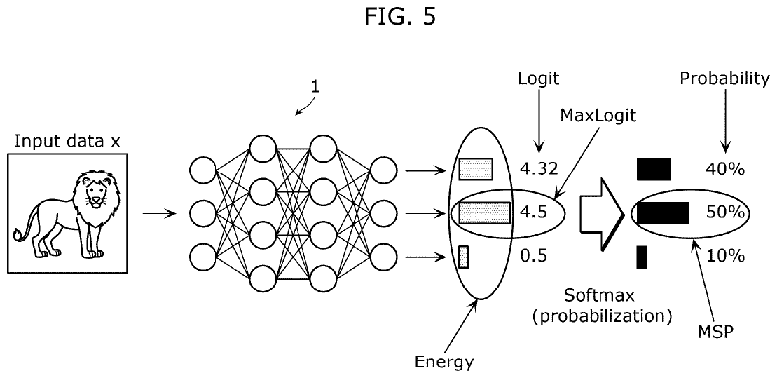

FIG. 5 is a diagram for explaining three OOD detection methods.

OOD detection methods include MSP, MaxLogit, and Energy. NPL 1 discloses MSP, and NPL 2 discloses MaxLogit. In MSP, numerical value h1(x) for the dog class, numerical value h2(x) for the cat class, and numerical value h3(x) for the bird class are output as probabilities, and then function S(h(x)) outputs the maximum value among numerical values h1(x), h2(x), and h3(x), which are probabilities, as an OOD score. In the example in FIG. 5, “50%” is output as the OOD score.

In MaxLogit, numerical value h1(x) for the dog class, numerical value h2(x) for the cat class, and numerical value h3(x) for the bird class are output as logits, and then function S(h(x)) outputs the maximum value among numerical values h1(x), h2(x), and h3(x), which are logits, as an OOD score. In the example in FIG. 5, “4.5” is output as the OOD score.

In Energy, numerical value h1(x) for the dog class, numerical value h2(x) for the cat class, and numerical value h3(x) for the bird class are output as logits, as with MaxLogit, and then function S(h(x)) outputs an OOD score by a computation using numerical values h1(x), h2(x), and h3(x) which are logits.

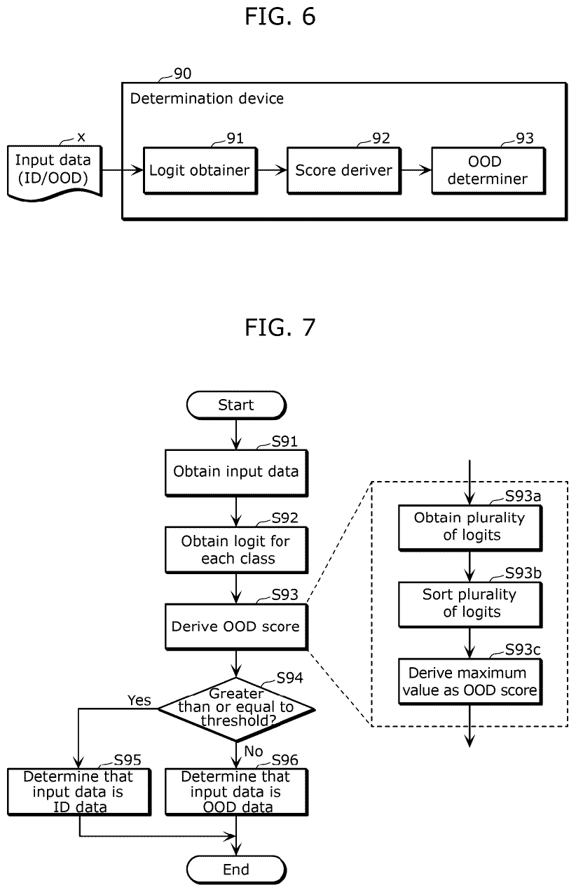

FIG. 6 is a block diagram illustrating an example of the structure of a determination device using MaxLogit.

Determination device 90 performs OOD detection using MaxLogit, and includes logit obtainer 91, score deriver 92, and OOD determiner 93.

Logit obtainer 91 obtains input data x, and inputs input data x to learning model 1 to obtain a plurality of logits for a plurality of classes from learning model 1.

Score deriver 92 selects the maximum logit (i.e., maximum value) among the plurality of logits obtained by logit obtainer 91, to derive the maximum value as an OOD score.

OOD determiner 93 compares the OOD score derived by score deriver 92 with threshold A to determine whether input data x is OOD data.

FIG. 7 is a flowchart illustrating an example of processing operations by determination device 90 using MaxLogit.

In determination device 90, first, logit obtainer 91 obtains input data x (Step S91), and inputs input data x to learning model 1 to obtain a logit for each class (Step S92). Next, score deriver 92 derives an OOD score for input data x (Step S93).

Specifically, score deriver 92 obtains the plurality of logits from logit obtainer 91 (Step S93a), and sorts the plurality of logits in order of magnitude (Step S93b). For example, the plurality of logits are sorted in descending order of magnitude. Score deriver 92 then selects the maximum value, that is, the logit at the highest position (hereinafter also referred to as top-1) as a result of the sorting, to derive the maximum value as an OOD score (Step S93c).

Next, OOD determiner 93 determines whether the OOD score is greater than or equal to threshold λ (Step S94). If the OOD score is greater than or equal to threshold λ (Yes in Step S94), OOD determiner 93 determines that input data x is ID data (Step S95). If the OOD score is less than threshold λ (No in Step S94), OOD determiner 93 determines that input data x is OOD data (Step S96).

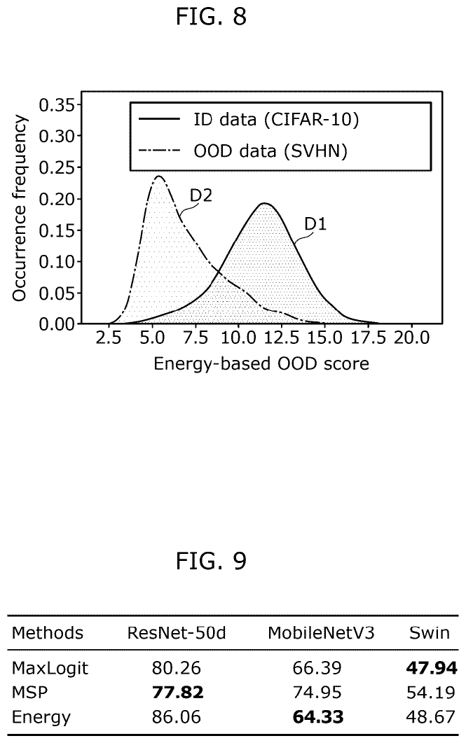

FIG. 8 is a diagram illustrating an example of a distribution of OOD scores based on Energy. Specifically, distribution D1 of ID data and distribution D2 of OOD data are illustrated in FIG. 8.

Distribution D1 represents the occurrence frequency of OOD scores derived by Energy when input data x that is ID data is input to learning model 1. Distribution D2 represents the occurrence frequency of OOD scores derived by Energy when input data x that is OOD data is input to learning model 1. The ID data is an image included in an image dataset of CIFAR-10, and the OOD data is an image included in an image dataset of SVHN.

As illustrated in FIG. 8, distributions D1 and D2 are not sufficiently separated and partially overlap. Therefore, if the OOD score is less than threshold, there is a possibility that the determination of input data x being OOD data is incorrect. In other words, input data x that is ID data may be erroneously determined to be OOD data, and conversely, input data x that is OOD data may be erroneously determined to be ID data. Thus, the determination accuracy of OOD detection is low.

FIG. 9 is a diagram illustrating an example of determination accuracy using three OOD detection methods.

The above-mentioned determination accuracy of OOD detection differs depending on the OOD detection method and also differs depending on learning model 1. For example, as illustrated in FIG. 9, the types of learning model 1 include ResNet-50d, MobileNetV3, and Swin, and the OOD detection methods include MaxLogit, MSP, and Energy mentioned above. The determination accuracy is expressed as an FPR95 value. When the FPR95 value is smaller, distributions D1 and D2 are separated more widely, and the determination accuracy is higher. The determination accuracy of OOD detection for the same type of learning model 1 differs depending on the OOD detection method, and the determination accuracy of OOD detection for the same OOD detection method differs depending on the type of learning model 1. Furthermore, these determination accuracies are not high.

The present disclosure accordingly provides a determination device capable of improving the accuracy of determining whether input data is OOD data, that is, the determination accuracy of OOD detection, regardless of the type of learning model.

A determination device according to a first aspect of the present disclosure includes: a logit obtainer that obtains, as a plurality of first logits, a plurality of logits for a plurality of classes by inputting input data to a learning model; a top-k determiner that determines, as m effective top-k elements, m top-k elements according to a characteristic of the learning model from among a plurality of top-k elements that are each a rank in order of magnitude of logits, where m is an integer of 1 or more; a first selector that selects m first logits corresponding to the m effective top-k elements from the plurality of first logits; a first score deriver that derives an out-of-distribution (OOD) score using the m first logits; and an OOD determiner that determines, based on the OOD score, whether the input data is OOD data.

In this way, not predetermined top-k (i.e., top-1) as in MaxLogit but m top-k elements according to the characteristics of the learning model are determined as m effective top-k elements. An OOD score is then derived using the m first logits corresponding to the m effective top-k elements. An appropriate OOD score can thus be derived. The use of such an OOD score improves the accuracy of determining whether input data is OOD data. Since high determination accuracy is stably ensured regardless of the type of learning model, robustness with respect to different learning model types can be achieved.

Specifically, the above-mentioned NPL 1 and NPL 2 have a problem in that it is difficult to determine with high accuracy whether input data is OOD data. However, the first aspect of the present disclosure is capable of improving the accuracy of determining whether input data is OOD data.

In a determination device according to a second aspect, each of the m first logits may be a first logit other than a maximum value among the plurality of first logits, the determination device may further include: a second selector that selects the maximum value from the plurality of first logits, and the first score deriver may derive the OOD score further using the maximum value. The second aspect may be subordinate to the first aspect.

In this way, not only the m first logits corresponding to the m effective top-k elements but also, for example, the maximum value, i.e., the first logit corresponding to top-1, is used to derive the OOD score. This further improves the foregoing determination accuracy.

In a determination device according to a third aspect, the OOD determiner may determine whether the input data is the OOD data by comparing the OOD score with a predetermined threshold. The third aspect may be subordinate to the first aspect or the second aspect.

In this way, whether input data is OOD data can be determined clearly.

A determination device according to a fourth aspect may further include: a second score deriver that derives an evaluation score of each of the plurality of top-k elements using a plurality of items of sample data that include one or more items of in-distribution (ID) data and one or more items of OOD data each as an item of sample data, and the top-k determiner may determine the m effective top-k elements based on the evaluation score of each of the plurality of top-k elements. The fourth aspect may be subordinate to any one of the first aspect to the third aspect.

In this way, the m effective top-k elements can be determined according to the difference between ID data and OOD data, with it being possible to appropriately improve the foregoing determination accuracy based on the m effective top-k elements.

In a determination device according to a fifth aspect, the second score deriver may derive the evaluation score of each of the plurality of top-k elements based on a plurality of second logits, the plurality of second logits being a plurality of logits for the plurality of classes obtained by inputting each of the plurality of items of sample data to the learning model. The fifth aspect may be subordinate to the fourth aspect.

In this way, the top-k elements for each of which the second logit differs significantly depending on whether sample data is ID data or OOD data can be determined as effective top-k elements. This improves the foregoing determination accuracy based on the m effective top-k elements more appropriately.

A determination device according to a sixth aspect may further include: a first sorter that sorts, for each of the plurality of items of sample data, the plurality of second logits that are based on the item of sample data in order of magnitude to associate the plurality of second logits with the plurality of top-k elements respectively, the second score deriver may derive, for each of the plurality of top-k elements, the evaluation score that increases with a degree of separation between a first distribution of one or more second logits that are based on the one or more items of ID data and are associated with the top-k element and a second distribution of one or more second logits that are based on the one or more items of OOD data and are associated with the top-k element. The sixth aspect may be subordinate to the fifth aspect. For example, the evaluation score may be a larger value when FPR95 is smaller, and may be “AUROC-FPR95”.

In this way, an effective evaluation score can be derived for each top-k element.

A determination device according to a seventh aspect may further include: a second sorter that sorts the plurality of top-k elements in order of the evaluation score, the top-k determiner may determine, as the m effective top-k elements, m highest top-k elements among the plurality of top-k elements sorted, excluding a predetermined top-k element, and the predetermined top-k element may be associated with a maximum value among the plurality of second logits sorted by the first sorter. The seventh aspect may be subordinate to the sixth aspect. For example, the predetermined top-k rank is top-1.

In this way, effective top-k elements unique to the learning model can be determined, excluding the predetermined top-k estimated to be effective for any learning model.

A determination device according to an eighth aspect may further include: a parameter determiner that determines, for each of the plurality of top-k elements, a sign corresponding to the top-k element based on the first distribution and the second distribution associated with the top-k element, as a parameter, the sign may be positive or negative, and the first score deriver may derive the OOD score further using the sign determined for each of the m effective top-k elements. The eighth aspect may be subordinate to the sixth aspect or the seventh aspect.

In this way, for each of the plurality of top-k elements, the relationship in magnitude between the second logit based on ID data and the second logit based on OOD data can be statistically represented as a sign. Since the sign is used in deriving the OOD score, the OOD score can reflect this relationship in magnitude. Thus, an effective OOD score for improving the foregoing determination accuracy can be derived.

In a determination device according to a ninth aspect, the parameter determiner may further determine, for each of the plurality of top-k elements, a standardization parameter corresponding to the top-k element based on at least one of the first distribution or the second distribution associated with the top-k element, and the first score deriver may derive the OOD score based on the standardization parameter determined for a top-k element corresponding to the maximum value among the plurality of first logits and the standardization parameter determined for each of the m effective top-k elements. The ninth aspect may be subordinate to any one of the sixth aspect to the eighth aspect. Examples of the standardization parameter include mean μ and standard deviation σ.

In this way, the OOD score is derived based on the standardization parameter, so that an appropriate OOD score reflecting statistical results based on a plurality of items of sample data can be derived for input data.

A determination device according to a tenth aspect may further include: a standardizer that performs a standardization process using the standardization parameter determined, in the standardization process, the standardizer may (a) standardize the maximum value among the plurality of first logits using the standardization parameter determined for the top-k element corresponding to the maximum value, and (b) standardize a first logit corresponding to each of the m effective top-k elements using the standardization parameter determined for the effective top-k element, and the first score deriver may apply the sign determined for each of the m effective top-k elements to the first logit standardized for the effective top-k element, to calculate a signed standardized first logit, and derive the OOD score by calculating a sum of the maximum value standardized and a mean of respective signed standardized first logits of the m effective top-k elements. The tenth aspect may be subordinate to any one of the sixth aspect to the ninth aspect.

In this way, a more appropriate OOD score can be derived, with it being possible to improve the foregoing determination accuracy more effectively.

A determination method according to an eleventh aspect of the present disclosure is a determination method executed by a computer, including: obtaining, as a plurality of first logits, a plurality of logits for a plurality of classes by inputting input data to a learning model; determining, as m effective top-k elements, m top-k elements according to a characteristic of the learning model from among a plurality of top-k elements that are each a rank in order of magnitude of logits, where m is an integer of 1 or more; selecting m first logits corresponding to the m effective top-k elements from the plurality of first logits; deriving an out-of-distribution (OOD) score using the m first logits; and determining, based on the OOD score, whether the input data is OOD data.

This has the same effects as the determination device according to the first aspect.

An embodiment will be described in detail below, with reference to the drawings.

The embodiment described below shows a general and specific example. The numerical values, shapes, materials, structural elements, the arrangement and connection of the structural elements, steps, the order of steps, etc. shown in the following embodiment are mere examples, and do not limit the scope of the present disclosure. Of the structural elements in the embodiment described below, the structural elements not recited in any one of the independent claims representing the broadest concepts are described as optional structural elements.

Each drawing is a schematic, and does not necessarily provide precise depiction. The same structural elements are given the same reference marks throughout the drawings. In the present disclosure, ordinal numbers such as “first” and “second” do not mean the numbers or order of structural elements unless otherwise specified, but are used for the purpose of avoiding confusion and distinguishing between structural elements of the same type.

### EMBODIMENT

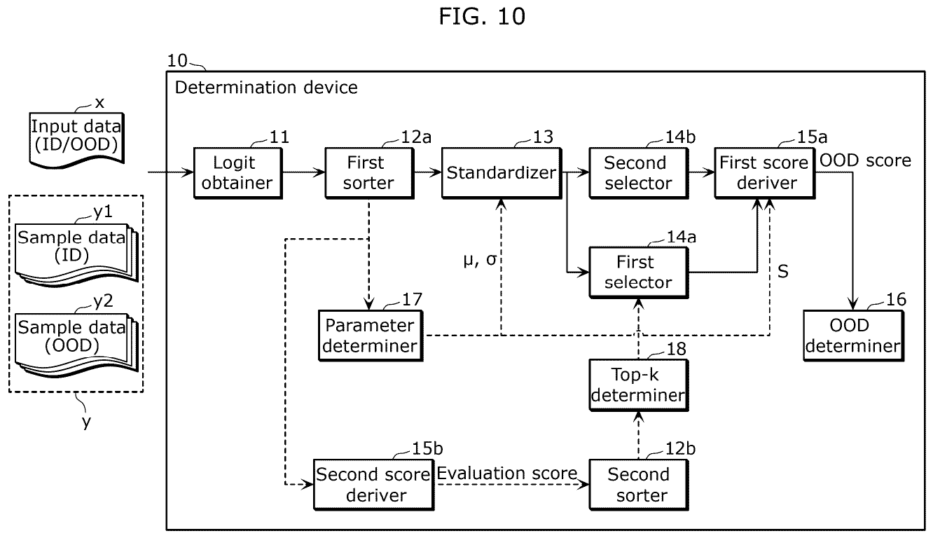

FIG. 10 is a block diagram illustrating an example of the structure of a determination device according to this embodiment.

Determination device 10 is a device that performs OOD detection using Adaptive Top-k Logit Integration (ATLI), and includes logit obtainer 11, first sorter 12a, second sorter 12b, standardizer 13, first selector 14a, second selector 14b, first score deriver 15a, second score deriver 15b, OOD determiner 16, parameter determiner 17, and top-k determiner 18. ATLI is an OOD detection method (i.e., determination method) in this embodiment.

Determination device 10 performs a second process for determining the below-described m effective top-k elements (where m is an integer of 1 or more), and performs a first process for OOD detection on input data x using the m effective top-k elements determined by the second process. In other words, the second process is performed first, and thereafter the first process is performed.

Logit obtainer 11, in the second process, obtains a plurality of items of sample data y, and inputs each of the plurality of items of sample data y to learning model 1 to obtain c logits for c classes from learning model 1. The plurality of items of sample data y include one or more items of ID data as sample data y1 and one or more items of OOD data as sample data y2. Each of the c logits obtained by the second process is also referred to as a second logit. Here, c is an integer of 2 or more.

Logit obtainer 11, in the first process, obtains input data x, and inputs input data x to learning model 1 to obtain c logits for c classes from learning model 1. Each of the c logits obtained by the first process is also referred to as a first logit. In other words, logit obtainer 11 inputs input data x to learning model 1 to obtain c logits for c classes as c first logits.

First sorter 12a sorts the c logits obtained by logit obtainer 11 in order of magnitude. The order of magnitude is hereinafter also referred to as logit order. Specifically, in the second process, when the c second logits are obtained by logit obtainer 11 for each of the plurality of items of sample data y, first sorter 12a sorts the c second logits in order of magnitude. In other words, for each of the plurality of items of sample data y, first sorter 12a sorts the c second logits based on sample data y in order of magnitude, thereby associating each of the c second logits with top-k. Top-k refers to a rank in order of magnitude of the logits (top-k is also referred to as “top-k element”).

Similarly, in the first process, when the c first logits are obtained by logit obtainer 11 for input data x, first sorter 12a sorts the c first logits in order of magnitude. In other words, first sorter 12a sorts the c first logits based on input data x in order of magnitude, thereby associating each of the c first logits with top-k.

In both the first and second processes, the c logits are sorted such that larger logits occupy higher positions. As a result of such sorting by first sorter 12a, the c logits are ranked. The rank corresponding to the maximum logit among the c logits (i.e., first rank) is also referred to as top-1.

Standardizer 13, in the first process, performs a standardization process using standardization parameters determined by parameter determiner 17. In the standardization process, for each of the c top-k elements, standardizer 13 standardizes the first logit corresponding to the top-k rank using the standardization parameters determined for the top-k rank. For example, the standardization parameters are mean μ and standard deviation σ.

First selector 14a, in the first process, selects m standardized first logits corresponding to m effective top-k elements determined by top-k determiner 18 (i.e., determined in the second process), from the c standardized first logits. The selected m standardized first logits are each a standardized first logit other than the maximum standardized first logit (i.e., maximum value) among the c standardized first logits.

Second selector 14b, in the first process, selects the maximum standardized first logit corresponding to top-1 from the c standardized first logits.

First score deriver 15a, in the first process, derives an OOD score using the m standardized first logits selected by first selector 14a and the maximum standardized first logit selected by second selector 14b. The OOD score is a real number. In other words, first score deriver 15a derives the OOD score based on the standardization parameters determined for the top-k rank corresponding to the maximum value (i.e., top-1) and the standardization parameters determined for each of the m effective top-k elements. First score deriver 15a also uses sign S determined by parameter determiner 17 for each of the m effective top-k elements, to derive the OOD score.

OOD determiner 16, in the first process, determines whether input data x is OOD data based on the OOD score derived by first score deriver 15a. Specifically, OOD determiner 16 compares the OOD score with predetermined threshold λ to determine whether input data x is OOD data. For example, OOD determiner 16 determines that input data x is ID data if the OOD score is greater than or equal to threshold λ, and determines that input data x is OOD data if the OOD score is less than threshold λ, as in the example illustrated in FIG. 4.

Parameter determiner 17, in the second process, determines, for each of the c top-k elements, sign S and standardization parameters (specifically, mean μ and standard deviation σ) corresponding to the top-k rank, as parameters.

Second score deriver 15b, in the second process, derives an evaluation score for each of the c top-k elements using the plurality of items of sample data y. The evaluation score is a real number. In detail, second score deriver 15b derives the evaluation score for each of the c top-k elements based on the c second logits, which are the c logits of the c classes obtained by inputting each of the plurality of items of sample data y to learning model 1.

Second sorter 12b sorts the c top-k elements in order of evaluation score. The order of evaluation score is hereinafter also referred to as score order. Second sorter 12b sorts the c top-k elements such that top-k elements with larger evaluation scores occupy higher positions. This sorting by second sorter 12b ranks the c top-k elements.

Top-k determiner 18 determines, as m effective top-k elements, m top-k elements according to the characteristics of learning model 1 among the c top-k elements which are each a rank in terms of the magnitude of the logits. Specifically, top-k determiner 18 determines the m effective top-k elements based on the evaluation scores of the c top-k elements.

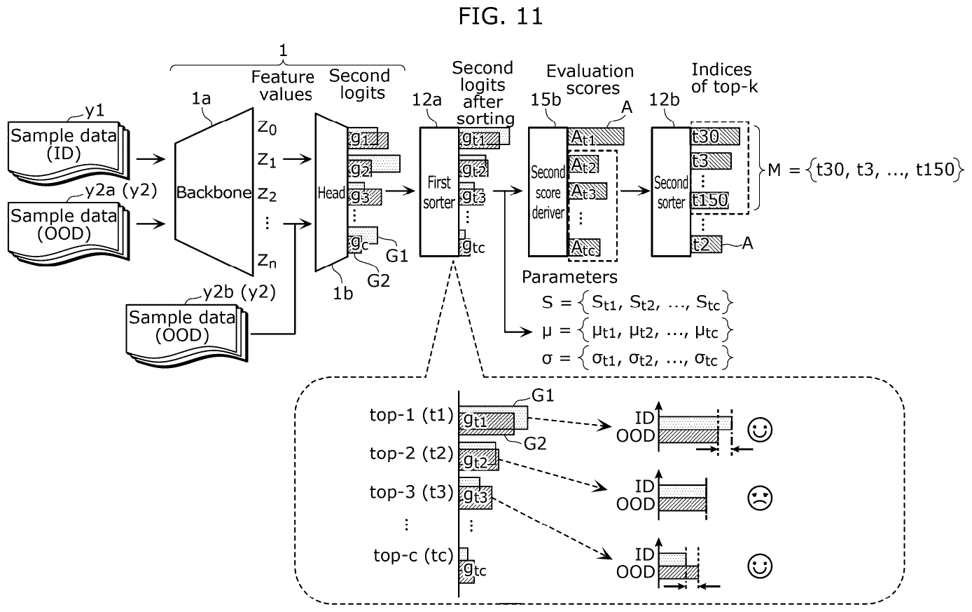

FIG. 11 is a diagram for explaining the second process by determination device 10 in this embodiment.

In the second process, logit obtainer 11 inputs the plurality of items of sample data y to learning model 1 that includes backbone 1a and head 1b. Each of the plurality of items of sample data y is, for example, image data. The plurality of items of sample data y include a plurality of items of sample data y1 each of which is ID data and a plurality of items of sample data y2 each of which is OOD data.

Each of the plurality of items of sample data y2 is also referred to as pseudo-OOD. The plurality of items of sample data y2 include a plurality of items of sample data y2a and a plurality of items of sample data y2b. Sample data y2a is data generated by Mixup. In detail, sample data y2a is generated by combining two items of ID data belonging to different classes, i.e., by calculating the linear sum of two items of ID data (i.e., images). Sample data y2b is generated by virtual outlier synthesis (VOS), i.e., generated by, when all ID data are regarded as one Gaussian distribution, sampling from low-likelihood regions of the Gaussian distribution. The ratio between the plurality of items of sample data y2a and the plurality of items of sample data y2b included in sample data y2 is, for example, 1:1.

Learning model 1 outputs, for each of the plurality of items of sample data y, c logits (i.e., second logits g₁ to g_{c}) of c classes based on sample data y. Logit obtainer 11 obtains c second logits g₁ to g_{c}. The c classes and c second logits g₁ to g_{c} are in a one-to-one correspondence. Thus, for each item of sample data y, logit obtainer 11 obtains c second logits g₁ to g_{c} corresponding to the c classes. For example, logit obtainer 11 obtains c second logits g₁ to g_{c} corresponding to the c classes based on sample data y1. Logit obtainer 11 further obtains c second logits g₁ to g_{c} corresponding to the c classes based on sample data y2a, and obtains c second logits g₁ to g_{c} corresponding to the c classes based on sample data y2b. In FIG. 11, the second logits based on sample data y1 are denoted as second logits G1, and the second logits based on sample data y2 are denoted as second logits G2.

First sorter 12a sorts c second logits g₁ to g_{c} obtained by logit obtainer 11 for each item of sample data y, thereby associating each of c second logits g₁ to g_{c} with top-k. Specifically, among c second logits g₁ to g_{c}, maximum second logit gₜ₁ is associated with the top-k (i.e., top-1) corresponding to the highest rank (i.e., first place), second largest second logit gₜ₂ is associated with the top-k (i.e., top-2) corresponding to the second place, third largest second logit gₜ₃ is associated with the top-k (i.e., top-3) corresponding to the third place, and minimum second logit g_{tc} is associated with the top-k (i.e., top-c) corresponding to the lowest rank (i.e., c-th place). In other words, second logits gₜ₁ to g_{tc} are associated with top-1 to top-c respectively. Indices t1 to tc are assigned to top-1 to top-c respectively.

Parameter determiner 17 determines, for each top-k, mean μ and standard deviation σ of the second logits associated with the top-k, as standardization parameters. In a specific example, parameter determiner 17 calculates mean μ and standard deviation σ of the distribution of the plurality of second logits that are based on the plurality of items of sample data y1 and are associated with the top-k. Alternatively, parameter determiner 17 calculates mean μ and standard deviation σ of the distribution of the plurality of second logits that are based on the plurality of items of sample data y2 and are associated with the top-k. Alternatively, parameter determiner 17 calculates mean μ and standard deviation σ of the distribution of the plurality of second logits that are based on the plurality of items of sample data y1 and the plurality of items of sample data y2 and are associated with the top-k.

Thus, in this embodiment, parameter determiner 17 determines, for each of the c top-k elements, the standardization parameters corresponding to the top-k based on at least one of a first distribution or a second distribution associated with the top-k. The first distribution is the distribution of the respective second logits based on the plurality of items of sample data y1 (i.e., the plurality of items of ID data) associated with the top-k. The second distribution is the distribution of the respective second logits based on the plurality of items of sample data y2 (i.e., the plurality of items of OOD data) associated with the top-k.

Parameter determiner 17 also determines, for each top-k element, sign S corresponding to the top-k as a parameter. For example, to determine sign S of top-i, which is the i-th top-k, parameter determiner 17 first calculates mean μᵢ of the first distribution at top-i, as set forth in (Formula 1) below. In (Formula 1), D is the number of second logits that are based on sample data y1 and are associated with top-i, and gₜₒₚ₋ᵢ(y1n) is the second logit identified by variable n among the D second logits that are based on sample data y1 and are associated with top-i.

$$[ Math . 1 ]$$

$${μ}_{i} = \frac{1}{D} {\sum }_{n = 1}^{D} {g}_{top - i} ( y {1}_{n} ) . \qquad ( Formula 1 )$$

Next, parameter determiner 17 calculates mean μ′ᵢ of the second distribution at top-i, as set forth in (Formula 2) below. In (Formula 2), D is the number of second logits that are based on sample data y2 and are associated with top-i, and gₜₒₚ₋ᵢ(y2n) is the second logit identified by variable n among the D second logits that are based on sample data y2 and are associated with top-i.

$$[ Math . 2 ]$$

$${μ}_{i}^{′} = \frac{1}{D} {\sum }_{n = 1}^{D} {g}_{top - i} ( y {2}_{n} ) . \qquad ( Formula 2 )$$

Parameter determiner 17 then determines sign Sᵢ(x), which is sign S of top-i, to be 1 (i.e., positive) if mean μᵢ is greater than or equal to mean μ′ᵢ, and determines sign Sᵢ(x), which is sign S of top-i, to −1 (i.e., negative) if mean μᵢ is less than mean μ′ᵢ, as set forth in (Formula 3).

$$[ Math . 3 ]$$

$${S}_{i} ( x ) = \{ \begin{matrix}1 & {μ}_{i} \geq {μ}_{i}^{′} \\ - 1 & {μ}_{i} < {μ}_{i}^{′}\end{matrix} . \qquad ( Formula 3 )$$

Thus, in this embodiment, parameter determiner 17 determines, for each of the c top-k elements, sign S corresponding to the top-k as a parameter based on the first and second distributions associated with the top-k. Sign S is either positive or negative.

In FIG. 11, signs S determined for top-1, top-2, . . . , top-c are denoted as S={Sₜ₁, Sₜ₂, . . . , S_{tc}}, means u determined for top-1, top-2, . . . , top-c are denoted as μ={μₜ₁, μₜ₂, . . . , μ_{tc}}, and standard deviations σ determined for top-1, top-2, . . . , top-c are denoted as σ={σₜ₁, σₜ₂, . . . , σ_{tc}}.

Second score deriver 15b derives, for each top-k, evaluation score A of the top-k. Specifically, second score deriver 15b derives evaluation scores Aₜ₁, Aₜ₂, Aₜ₃, . . . , A_{tc} for top-1, top-2, top-3, . . . , top-c. In detail, for each of the c top-k elements, second score deriver 15b derives higher evaluation score A for the top-k when the degree of separation between the first distribution of the second logits that are based on the plurality of items of ID data and are associated with the top-k and the second distribution of the second logits that are based on the plurality of items of OOD data and are associated with the top-k is larger. The plurality of items of ID data are the plurality of items of sample data y1, and the plurality of items of OOD data are the plurality of items of sample data y2. The degree of separation may be expressed using the false positive rate at 95% true positive rate (i.e., FPR95). Here, the degree of separation is larger when FPR95 is smaller. Alternatively, the degree of separation may be expressed as “area under the ROC curve (AUROC)—FPR95”.

Second sorter 12b sorts the c top-k elements in order of evaluation score A (i.e., in score order). In detail, second sorter 12b sorts the c top-k elements in the order of “top-k corresponding to maximum evaluation score A”, “top-k corresponding to second largest evaluation score A”, “top-k corresponding to third largest evaluation score A”, . . . , “top-k corresponding to c-th largest evaluation score A”. In other words, indices t1 to tc of the c top-k elements are sorted.

Top-k determiner 18 determines, from among the c top-k elements sorted by second sorter 12b, m highest top-k elements in score order excluding the top-k that is at the highest position in logit order (i.e., top-1 or t1), as m effective top-k elements. The top-k at the highest position in logit order (i.e., top-1 or t1) is basically the top-k corresponding to highest evaluation score A. For example, in the example in FIG. 11, the m top-k elements corresponding to indices t30, t3, . . . , t150 are determined as the m effective top-k elements. In FIG. 11, set M of the m effective top-k elements is denoted as M={t30, t3, . . . , t150}.

Hence, when second logits are associated with each top-k by first sorter 12a, top-k for which the difference between second logit G1 based on sample data y1 (i.e., ID data) and second logit G2 based on sample data y2 (i.e., OOD data) is larger is more likely to be determined as effective top-k.

Thus, in this embodiment, top-k determiner 18 determines, from among the c top-k elements sorted by second sorter 12b, m highest top-k elements excluding a predetermined top-k, as m effective top-k elements. The predetermined top-k is the top-k (i.e., top-1) associated with the maximum value among the c second logits gₜ₁ to g_{tc} sorted by first sorter 12a. For example, m is 10% of c. Top-k determiner 18 may determine, from among the c top-k elements sorted by second sorter 12b, m top-k elements for which the difference between second logits G1 and G2 is greater than or equal to a predetermined threshold, as m effective top-k elements.

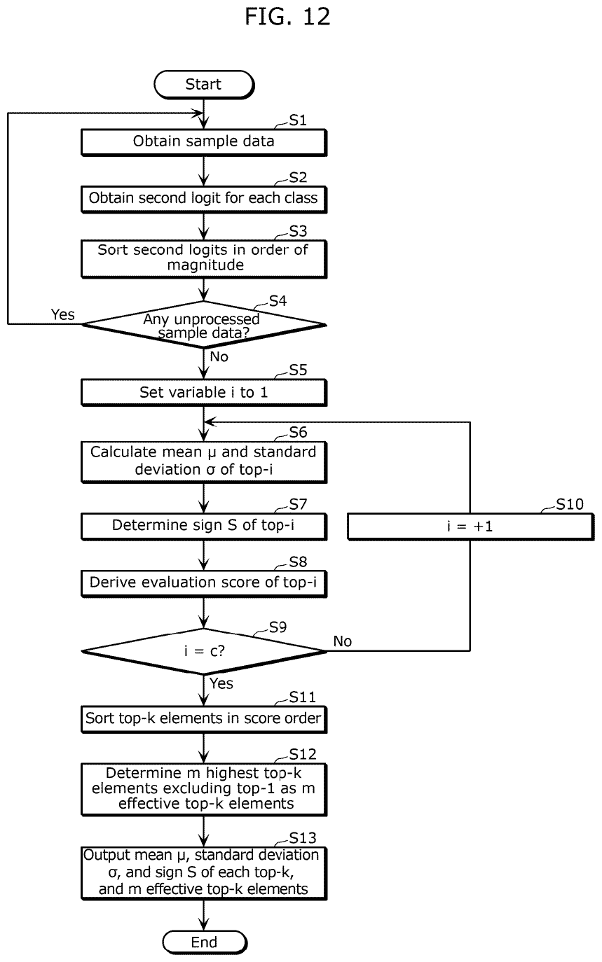

FIG. 12 is a flowchart illustrating an example of the second process by determination device 10.

First, logit obtainer 11 obtains sample data y (Step S1), and inputs sample data y to learning model 1 to obtain c second logits g₁ to g_{c} for c classes (Step S2). Next, first sorter 12a sorts c second logits g₁ to g_{c} in order of magnitude (Step S3). Logit obtainer 11 determines whether there is any unprocessed sample data y for which second logits g₁ to g_{c} have not been obtained (Step S4). If logit obtainer 11 determines that there is unprocessed sample data y (Yes in Step S4), the processing from Step S1 is repeated. If logit obtainer 11 determines that there is no unprocessed sample data y (No in Step S4), parameter determiner 17 initializes variable i by assigning 1 to variable i (Step S5). Variable i identifies one of the c top-k elements, and the top-k identified by variable i is denoted as top-i. When i=1, the top-k identified by variable i is top-1. When i=2, the top-k identified by variable i is top-2. When i=c, the top-k identified by variable i is top-c.

Next, parameter determiner 17 calculates mean μ and standard deviation σ corresponding to top-i, as standardization parameters (Step S6). Thus, the standardization parameters of top-i are determined. Parameter determiner 17 also determines sign S corresponding to top-i (Step S7). Then, second score deriver 15b derives evaluation score A corresponding to top-i (Step S8). After this, parameter determiner 17 determines whether variable i equals c (Step S9). If parameter determiner 17 determines that variable i does not equal c (No in Step S9), parameter determiner 17 increments variable i (Step S10). Parameter determiner 17 and second score deriver 15b then repeat the processing from Step S6.

If parameter determiner 17 determines that variable i equals c (Yes in Step S9), second sorter 12b sorts the c top-k elements (Step S11). Specifically, second sorter 12b sorts the c top-k elements in score order using evaluation score A derived for each of the c top-k elements in Step S8. Following this, top-k determiner 18 determines, as m effective top-k elements, the m highest top-k elements in score order excluding top-1 from among the c top-k elements sorted by second sorter 12b (Step S12).

After this, parameter determiner 17 outputs, for each of the c top-k elements, mean μ and standard deviation σ calculated in Step S6 to standardizer 13, and sign S determined in Step S7 to first score deriver 15a. Moreover, top-k determiner 18 outputs the m effective top-k elements determined in Step S12 to first selector 14a (Step S13).

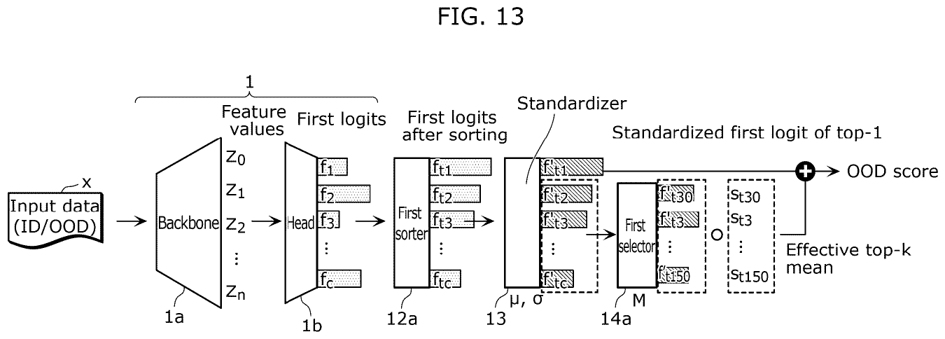

FIG. 13 is a diagram for explaining the first process by determination device 10 in this embodiment.

In the first process, logit obtainer 11 inputs input data x to learning model 1 that includes backbone 1a and head 1b. Input data x is, for example, image data, and is either ID data or OOD data. As a result, learning model 1 outputs c logits (i.e., first logits f₁ to f_{c}) of c classes based on input data x. Logit obtainer 11 obtains c first logits f₁ to f_{c}. The c classes and c first logits f₁ to f_{c} are in a one-to-one correspondence.

First sorter 12a sorts c first logits f₁ to f_{c} obtained by logit obtainer 11 for each item of sample data y, thereby associating each of c first logits f₁ to f_{c} with top-k. Specifically, among c first logits f₁ to f_{c}, maximum first logit fₜ₁ is associated with the top-k (i.e., top-1) corresponding to the highest rank (i.e., first place), second largest first logit fₜ₂ is associated with the top-k (i.e., top-2) corresponding to the second place, third largest first logit fₜ₃ is associated with the top-k (i.e., top-3) corresponding to the third place, and minimum first logit f_{tc} is associated with the top-k (i.e., top-c) corresponding to the lowest rank (i.e., c-th place).

Standardizer 13 performs a standardization process. In detail, standardizer 13 standardizes c sorted first logits fₜ₁ to f_{tc} to generate c standardized first logits f′ₜ₁ to f′_{tc}. The standardization process uses the standardization parameters (i.e., mean μ and standard deviation σ) for each top-k element calculated by parameter determiner 17. For example, standardizer 13 applies mean μ and standard deviation σ calculated for top-1 to first logit fₜ₁ corresponding to top-1, to generate standardized first logit f′ₜ₁. Likewise, standardizer 13 applies mean μ and standard deviation σ calculated for top-2 to first logit fₜ₂ corresponding to top-2, to generate standardized first logit f′ₜ₂.

Specifically, standardizer 13 calculates the standardized first logits according to (Formula 4) below. In (Formula 4), f′ₜₒₚ₋ᵢ(x) is the standardized first logit corresponding to top-i, fₜₒₚ₋ᵢ(x) is the first logit corresponding to top-i, μᵢ is mean μ corresponding to top-i, and σᵢ is standard deviation σ corresponding to top-i.

$$[ Math . 4 ]$$

$${f}_{top - i}^{′} ( x ) = ( {f}_{top - i} ( x ) - {μ}_{i} ) / {σ}_{i} . \qquad ( Formula 4 )$$

Here, c first logits fₜ₁ to f_{tc} include the maximum value and the m first logits corresponding to the m effective top-k elements. Therefore, in this embodiment, standardizer 13 performs the standardization process in which (a) the maximum value is standardized using the standardization parameters determined for the top-k corresponding to the maximum value, and (b) for each of the m effective top-k elements, the first logit corresponding to the effective top-k is standardized using the standardization parameters determined for the effective top-k.

First selector 14a selects, from c standardized first logits f′ₜ₁ to f′_{tc}, the m standardized first logits corresponding to the m effective top-k elements (i.e., set M) determined by top-k determiner 18. For example, the m effective top-k elements include top-30, top-3, and top-150. In this case, for example, the m standardized first logits selected by first selector 14a include standardized first logit f′ₜ₃₀ corresponding to top-30 (i.e., index t30), standardized first logit f′ₜ₃ corresponding to top-3 (i.e., index t3), and standardized first logit f′ₜ₁₅₀ corresponding to top-150 (i.e., index t150), as illustrated in FIG. 13.

First score deriver 15a obtains the m standardized first logits selected by first selector 14a. First score deriver 15a also obtains, from parameter determiner 17, sign S corresponding to each of the m effective top-k elements among signs S determined for the respective top-k elements by parameter determiner 17. First score deriver 15a then applies, for each of the m effective top-k elements, sign S of the effective top-k to the standardized first logit corresponding to the effective top-k, thereby deriving a signed standardized first logit. For example, suppose sign Sₜ₃₀, sign Sₜ₃, and sign Sₜ₁₅₀ are determined for top-30, top-3, and top-150 respectively. In this case, first score deriver 15a applies sign Sₜ₃₀ of top-30 to standardized first logit f′ₜ₃₀ corresponding to top-30, applies sign Sₜ₃ of top-3 to standardized first logit f′ₜ₃ corresponding to top-3, and applies sign Sₜ₁₅₀ of top-150 to standardized first logit f′ₜ₁₅₀ corresponding to top-150. First score deriver 15a then calculates a mean of the respective signed standardized first logits of the m effective top-k elements.

Next, first score deriver 15a obtains standardized first logit f′ₜ₁ corresponding to top-1 from standardizer 13. First score deriver 15a adds the mean of the signed standardized first logits calculated as described above to standardized first logit f′ₜ₁, to derive an OOD score for input data x.

In detail, first score deriver 15a calculates the OOD score according to (Formula 5) below. In (Formula 5), f′ₜₒₚ₋₁(x) is standardized first logit f′ₜ₁ corresponding to top-1, f′ₜₒₚ₋ᵢ(x) is the standardized first logit corresponding to top-i, M is the set of variables i indicating effective top-k elements, |M| is the number of elements in the set, which is m, and Sᵢ is sign S determined for top-i.

$$[ Math . 5 ]$$

$$ATLI ( x : f ) = {f}_{top - 1}^{′} ( x ) + \frac{1}{\vert M \vert} {\sum }_{i ∈ M} {S}_{i} \cdot {f}_{top - i}^{′} ( x ) . \qquad ( Formula 5 )$$

Thus, in this embodiment, first score deriver 15a applies, for each of the m effective top-k elements, sign S determined for the effective top-k to the standardized first logit corresponding to the effective top-k, thereby calculating the signed standardized first logit. First score deriver 15a then derives the OOD score by calculating the sum of the standardized maximum value, which is standardized first logit f′ₜ₁ corresponding to top-1, and the mean of the signed standardized first logits of the m effective top-k elements.

OOD determiner 16 determines whether input data x is OOD data by comparing the derived OOD score with threshold λ.

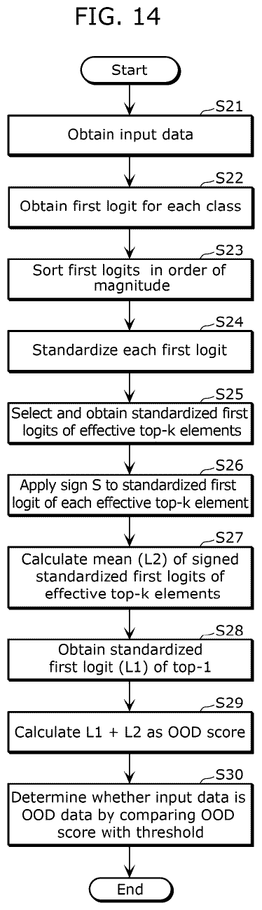

FIG. 14 is a flowchart illustrating an example of the first process by determination device 10.

First, logit obtainer 11 obtains input data x (Step S21), and inputs input data x to learning model 1 to obtain c first logits f₁ to f_{c} for c classes (Step S22). Next, first sorter 12a sorts c first logits f₁ to f_{c} in order of magnitude (Step S23). Then, standardizer 13 standardizes c sorted first logits fₜ₁ to f_{tc} to generate c standardized first logits f′ₜ₁ to f′_{tc} (Step S24).

Next, first selector 14a selects the m standardized first logits corresponding to the m effective top-k elements, and first score deriver 15a obtains the m standardized first logits (Step S25). First score deriver 15a then applies, for each of the m effective top-k elements, sign S of the effective top-k to the standardized first logit corresponding to that effective top-k to derive a signed standardized first logit (Step S26). First score deriver 15a then calculates a mean of the signed standardized first logits of the respective m effective top-k elements as L2 (Step S27).

Next, first score deriver 15a obtains standardized first logit f′ₜ₁ corresponding to top-1 from standardizer 13, as L1 (Step S28). First score deriver 15a then calculates an OOD score for input data x as L1+L2 (Step S29). OOD determiner 16 determines whether input data x is OOD data by comparing the OOD score calculated in Step S29 with threshold λ (Step S30).

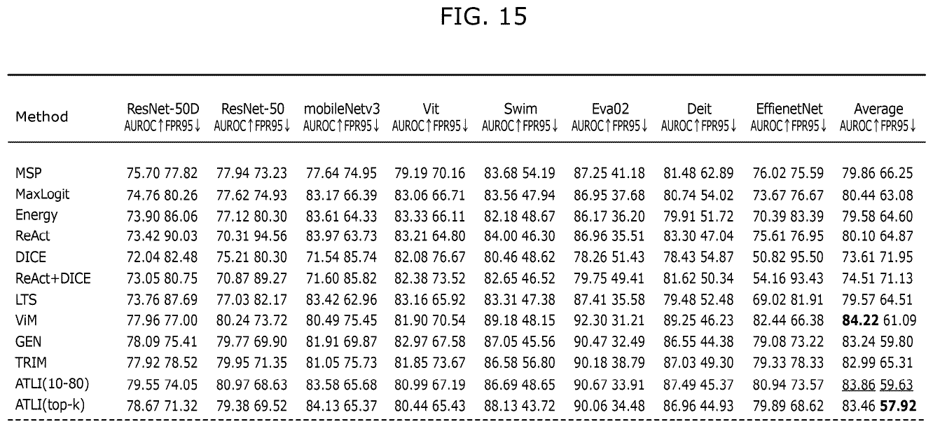

FIG. 15 is a diagram illustrating an example of determination accuracy by determination device 10 in this embodiment. In FIG. 15, the determination accuracy of each of twelve OOD detection methods is indicated for each of eight learning models. The average determination accuracy across the eight learning models for each of the twelve OOD detection methods is also indicated in the drawing. The determination accuracy is expressed in terms of AUROC and FPR95.

The OOD detection method using determination device 10 in this embodiment is ATLI (top-k). With this method, the average FPR95 (i.e., 57.92) is the lowest. That is, the determination accuracy based on FPR95 by ATLI (top-k) is the highest among the twelve methods. Moreover, with this method, the average AUROC (i.e., 83.46) is the third highest among the twelve methods. The determination accuracy can also be expressed as (average AUROC)−(average FPR95). This determination accuracy of ATLI (top-k) is also the highest among the twelve methods. In addition, ATLI (top-k) has consistently high determination accuracy for each of the eight learning models. Thus, ATLI (top-k) has high determination accuracy and robustness with respect to different types of learning model 1.

As described in above, this embodiment, not predetermined top-k (i.e., top-1) as in MaxLogit but m top-k elements according to the characteristics of learning model 1 are determined as m effective top-k elements. An OOD score is then derived using the m first logits corresponding to the m effective top-k elements. An appropriate OOD score can thus be derived. The use of such an OOD score improves the accuracy of determining whether input data x is OOD data. Since high determination accuracy is stably ensured regardless of the type of learning model 1, robustness with respect to different types of learning model 1 can be achieved.

Moreover, in this embodiment, not only the m first logits corresponding to the m effective top-k elements but also, for example, the maximum value, i.e., the first logit corresponding to top-1, is used to derive the OOD score. This further improves the foregoing determination accuracy.

Moreover, in this embodiment, whether input data x is OOD data is determined by comparing the OOD score with threshold λ. Hence, whether input data is OOD data can be determined clearly.

Moreover, in this embodiment, evaluation score A of each of the c top-k elements is derived using a plurality of items of sample data y that include one or more items of in-distribution (ID) data each as sample data y1 and one or more items of OOD data each as sample data y2. The m effective top-k elements are then determined based on evaluation score A of each of the c top-k elements. In this way, the m effective top-k elements can be determined according to the difference between ID data and OOD data, with it being possible to appropriately improve the foregoing determination accuracy based on the m effective top-k elements.

Moreover, in this embodiment, evaluation score A of each of the c top-k elements is derived based on c second logits for the c classes obtained by inputting each of the plurality of items of sample data y to learning model 1. In this way, the top-k elements for each of which the second logit differs significantly depending on whether sample data y is ID data or OOD data can be determined as effective top-k elements. This improves the foregoing determination accuracy based on the m effective top-k elements more appropriately.

Moreover, in this embodiment, for each of the plurality of items of sample data y, the c second logits that are based on item of sample data y are sorted in order of magnitude to associate the c second logits with the respective top-k elements. Then, for each of the c top-k elements, evaluation score A that increases with a degree of separation between a first distribution of one or more second logits that are based on the one or more items of ID data and are associated with the top-k element and a second distribution of one or more second logits that are based on the one or more items of OOD data and are associated with the top-k element is derived. In this way, effective evaluation score A can be derived for each top-k element.

Moreover, in this embodiment, the c top-k elements are sorted in order of evaluation score A. Then, as the m effective top-k elements, m highest top-k elements among the c top-k elements sorted, excluding top-1, are determined. In this way, effective top-k elements unique to the learning model can be determined, excluding top-1 estimated to be effective for any learning model 1.

Moreover, in this embodiment, for each of the c top-k elements, sign S corresponding to the top-k element is determined based on the first distribution and the second distribution associated with the top-k element. Then, the OOD score is derived further using sign S determined for each of the m effective top-k elements. In this way, for each of the c top-k elements, the relationship in magnitude between the second logit based on ID data and the second logit based on OOD data can be statistically represented as sign S. Since sign S is used in deriving the OOD score, the OOD score can reflect this relationship in magnitude. Thus, an effective OOD score for improving the foregoing determination accuracy can be derived.

Moreover, in this embodiment, for each of the c top-k elements, a standardization parameter corresponding to the top-k element is determined based on at least one of the first distribution or the second distribution associated with the top-k element. The OOD score is derived based on the standardization parameter determined for a top-k element corresponding to the maximum value among the plurality of first logits and the standardization parameter determined for each of the m effective top-k elements. In this way, the OOD score is derived based on the standardization parameter, so that an appropriate OOD score reflecting statistical results based on a plurality of items of sample data y can be derived for input data x.

Moreover, in this embodiment, the standardization parameter determined for the top-k element corresponding to the maximum value is used to standardize the maximum value.

Further, for each of the m effective top-k elements, the standardization parameter determined for the effective top-k element is used to standardize a first logit corresponding to the effective top-k element. Then, for each of the m effective top-k elements, sign S determined for the effective top-k element is applied to the first logit standardized for the effective top-k element, to calculate a signed standardized first logit. After this, the OOD score is derived by calculating a sum of the maximum value standardized and a mean of respective signed standardized first logits of the m effective top-k elements. In this way, a more appropriate OOD score can be derived, with it being possible to improve the foregoing determination accuracy more effectively.

Moreover, the plurality of items of sample data y2 used in the second process in this embodiment include a plurality of items of sample data y2a and a plurality of items of sample data y2b. In other words, a plurality of pseudo-OOD samples used in the second process include a plurality of pseudo-OOD samples generated by Mixup and a plurality of pseudo-OOD samples generated by VOS. Hence, pseudo-OOD can be generated at low cost. Furthermore, pseudo-OOD covering a wide range of the feature space can be used, so that effective top-k elements which are efficient can be determined.

Determination device 10 according to the present disclosure has been described above based on the above embodiment, but the present disclosure is not limited to the above embodiment. Modifications obtained by applying various changes conceivable by a person skilled in the art to the above embodiment may also be included in the scope of the present disclosure, without departing from the scope of the present disclosure.

Each of the structural elements in the above embodiment may be configured in the form of dedicated hardware, or may be implemented by executing a software program suitable for the structural element. Each of the structural elements may be implemented by means of a program executing unit, such as a central processing unit (CPU) and a processor, reading and executing the software program recorded on a recording medium such as a hard disk or semiconductor memory. Software that implements determination device 10, etc. according to the above embodiment is a computer program for causing a computer to execute each step in the flowcharts of FIGS. 12 and 14.

The following are also included in the scope of the present disclosure.
(1) The above device is specifically a computer system including a microprocessor, a ROM, a RAM, a hard disk unit, a display unit, a keyboard, a mouse, and the like. A computer program is recorded in the RAM or the hard disk unit. The above device achieves its functions by the microprocessor operating according to the computer program. The computer program is configured by combining multiple command codes indicating instructions to the computer, to achieve predetermined functions.
(2) Part or all of the structural elements constituting the above device may be configured as a single system large scale integration (LSI). A system LSI is a super-multifunctional LSI manufactured integrating multiple components on a single chip, and specifically is a computer system including a microprocessor, a ROM, a RAM, and the like. A computer program is recorded in the RAM. The system LSI achieves its functions by the microprocessor operating according to the computer program.
(3) Part or all of the structural elements constituting the above device may be configured as an IC card detachably mountable to the device or a standalone module. The IC card or the module is a computer system including a microprocessor, a ROM, a RAM, and the like. The IC card or the module may include the above-described super-multifunctional LSI. The IC card or the module achieves its functions by the microprocessor operating according to the computer program. The IC card or the module may be tamper-resistant.
(4) The present disclosure may be the above-described methods, or may be a computer program which realizes these methods by a computer, or may be digital signals made up of the computer program.

The present disclosure may be the computer program or the digital signals recorded on a computer-readable recording medium, such as flexible disk, hard disk, compact disc (CD)-ROM, DVD, DVD-ROM, DVD-RAM, Blu-ray (registered trademark) disc (BD), or semiconductor memory. The present disclosure may also be the digital signals recorded on these recording mediums.

The present disclosure may be an arrangement where the computer program or the digital signals are transmitted over an electric communication line, a wireless or wired communication line, a network such as the Internet, data broadcasting, or the like.

The present disclosure may also be carried out by another independent computer system, by the program or the digital signals being recorded on the recording medium and being transported, or by the program or the digital signals being transferred over the network or the like.

Further Information about Technical Background to this Application

The disclosures of the following patent applications including specification, drawings, and claims are incorporated herein by reference in their entirety: Japanese Patent Application No. 2025-013819 filed on Jan. 30, 2025, and Japanese Patent Application No. 2025-131154 filed on Aug. 6, 2025.

### INDUSTRIAL APPLICABILITY

The determination device according to the present disclosure can be applied, for example, to systems using learning models.

1. A determination device comprising:
a processor; and
a memory connected to the memory,
wherein, using the memory, the processor executes the following processes of:
obtaining, as a plurality of first logits, a plurality of logits for a plurality of classes by inputting input data to a learning model;
top-k determining of determining, as m effective top-k elements, m top-k elements according to a characteristic of the learning model from among a plurality of top-k elements that are each a rank in order of magnitude of logits, where m is an integer of 1 or more;
first selecting of selecting m first logits corresponding to the m effective top-k elements from the plurality of first logits;
first score deriving of deriving an out-of-distribution (OOD) score using the m first logits; and
OOD determining of determining, based on the OOD score, whether the input data is OOD data.

2. The determination device according to claim 1,
wherein each of the m first logits is a first logit other than a maximum value among the plurality of first logits,
the processor further executes second selecting of selecting the maximum value from the plurality of first logits, and
in the first score deriving, the processor derives the OOD score further using the maximum value.

3. The determination device according to claim 1,
wherein, in the OOD determining, the processor determines whether the input data is the OOD data by comparing the OOD score with a predetermined threshold.

4. The determination device according to claim 2,
wherein the processor further executes: second score deriving of deriving an evaluation score of each of the plurality of top-k elements using a plurality of items of sample data that include one or more items of in-distribution (ID) data and one or more items of OOD data each as an item of sample data, and
in the top-k determining, the processor determines the m effective top-k elements based on the evaluation score of each of the plurality of top-k elements.

5. The determination device according to claim 4,
wherein, in the second score deriving, the processor executes a process of deriving the evaluation score of each of the plurality of top-k elements based on a plurality of second logits, the plurality of second logits being a plurality of logits for the plurality of classes obtained by inputting each of the plurality of items of sample data to the learning model.

6. The determination device according to claim 5,
wherein the processor further executes: first sorting of sorting, for each of the plurality of items of sample data, the plurality of second logits that are based on the item of sample data in order of magnitude to associate the plurality of second logits with the plurality of top-k elements respectively, and
in the second score deriving, the processor derives, for each of the plurality of top-k elements, the evaluation score that increases with a degree of separation between a first distribution of one or more second logits that are based on the one or more items of ID data and are associated with the top-k element and a second distribution of one or more second logits that are based on the one or more items of OOD data and are associated with the top-k element.

7. The determination device according to claim 6,
wherein the processor further executes: second sorting of sorting the plurality of top-k elements in order of the evaluation score, and
in the top-k determining, the processor determines, as the m effective top-k elements, m highest top-k elements among the plurality of top-k elements sorted, excluding a predetermined top-k element, and
the predetermined top-k element is associated with a maximum value among the plurality of second logits sorted in the first sorting.

8. The determination device according to claim 7,
wherein the processor further executes: parameter determining of determining, for each of the plurality of top-k elements, a sign corresponding to the top-k element based on the first distribution and the second distribution associated with the top-k element, as a parameter,
the sign is positive or negative, and
in the first score deriving, the processor derives the OOD score further using the sign determined for each of the m effective top-k elements.

9. The determination device according to claim 8,
wherein, in the parameter determining, the processor further determines, for each of the plurality of top-k elements, a standardization parameter corresponding to the top-k element based on at least one of the first distribution or the second distribution associated with the top-k element, and
in the first score deriving, the processor derives the OOD score based on the standardization parameter determined for a top-k element corresponding to the maximum value among the plurality of first logits and the standardization parameter determined for each of the m effective top-k elements.

10. The determination device according to claim 9,
wherein the processor further executes standardizing of performing a standardization process using the standardization parameter determined, and
in the standardization process, the processor
(a) standardizes the maximum value among the plurality of first logits using the standardization parameter determined for the top-k element corresponding to the maximum value, and
(b) standardizes a first logit corresponding to each of the m effective top-k elements using the standardization parameter determined for the effective top-k element, and
in the first score deriving, the processor:
applies the sign determined for each of the m effective top-k elements to the first logit standardized for the effective top-k element, to calculate a signed standardized first logit, and
derives the OOD score by calculating a sum of the maximum value standardized and a mean of respective signed standardized first logits of the m effective top-k elements.

11. A determination method executed by a computer, the determination method comprising:
obtaining, as a plurality of first logits, a plurality of logits for a plurality of classes by inputting input data to a learning model;
determining, as m effective top-k elements, m top-k elements according to a characteristic of the learning model from among a plurality of top-k elements that are each a rank in order of magnitude of logits, where m is an integer of 1 or more;
selecting m first logits corresponding to the m effective top-k elements from the plurality of first logits;
deriving an out-of-distribution (OOD) score using the m first logits; and
determining, based on the OOD score, whether the input data is OOD data.
